(19) United States
(12) Patent Application Publication
(10) Pub. No.: US 2026/0277950 A1
(43) Pub. Date: Sep. 17, 2026

(54) QUESTION-ANSWERING WITH DOMAIN-SPECIFIC KNOWLEDGE GRAPH

(71) Applicant: INTERNATIONAL BUSINESS MACHINES CORPORATION, ARMONK, NY (US)

(72) Inventors: Anupam Chakraborty, Bengaluru (IN); Shilpa Hegde, Bengaluru (IN); Mohit Sharma, Bangalore (IN)

(21) Appl. No.: 19/081,775

(22) Filed: Mar. 17, 2025

(51) Int. Cl. G06F 16/3329; G06F 16/353; G06N 5/022

(52) U.S. Cl. CPC G06F 16/33295; G06F 16/353; G06N 5/022

(57) ABSTRACT

A method, computer system, and a computer program product for question-answering is provided. The present invention may include executing a plurality of AI agents to generate a domain schema for a knowledge graph. The present invention may include extracting from a plurality of domain documents, a plurality of instance data corresponding to the domain schema. The present invention may include constructing the knowledge graph by integrating the domain schema and the plurality of instance data extracted from the plurality of domain documents. The present invention may include classifying a natural language (NL) query from a user as answerable by the knowledge graph. The present invention may include translating the NL query from the user into a graph language query. The present invention may include executing the graph language query on the knowledge graph to output a graph-based query response to the user.

### BACKGROUND

The present invention relates generally to the field of computing, and more particularly to information retrieval systems.

Unstructured datasets typically comprise the majority of all enterprise-generated data. These unstructured datasets often contain valuable domain-specific information and actionable insights. Organizations have tried to operationalize their unstructured data by implementing large language models (LLM) to retrieve information from these datasets. However, given the existing limitations of LLMs (e.g., context length; hallucinations), there is a need for an improved information retrieval solution that is optimized for computing cost, response time, response accuracy, and scalability.

### SUMMARY

Embodiments of the present invention disclose a method, computer system, and a computer program product for question-answering. The present invention may include executing a plurality of AI agents to generate a domain schema for a knowledge graph. The present invention may include extracting from a plurality of domain documents, a plurality of instance data corresponding to the domain schema. The present invention may include constructing the knowledge graph by integrating the domain schema and the plurality of instance data extracted from the plurality of domain documents. The present invention may include classifying a natural language (NL) query from a user as answerable by the knowledge graph. The present invention may include translating the NL query from the user into a graph language query. The present invention may include executing the graph language query on the knowledge graph to output a graph-based query response to the user.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computing environment according to at least one embodiment;

FIG. 2 is a schematic block diagram of a domain modeling environment according to at least one embodiment;

FIG. 3 is a schematic block diagram of a graph building environment according to at least one embodiment;

FIG. 4 is a schematic block diagram of question-answering environment according to at least one embodiment; and

FIG. 5 is an operational flowchart illustrating a process for information retrieval according to at least one embodiment.

### DETAILED DESCRIPTION

The following described exemplary embodiments provide a system, method and computer program product for question-answering with domain-specific knowledge graphs. As such, the present embodiment has the capacity to improve the technical field of information retrieval by solving for LLM limitations when answering questions from multiple documents with logical operators (e.g., and, or, not) and comparison operators (e.g., >, <, =). The present embodiment also has the capacity to improve the technical field of information retrieval by solving for the limitations of question-answering systems where answers cannot be found in a single document but instead by analysing the relationship between different concepts from multiple documents. More specifically, an information retrieval program may execute artificial intelligence (AI) agents to generate a domain schema for a knowledge graph in a specific domain. Then, the information retrieval program may ingest domain documents and extract, from the domain documents, instance data corresponding to the domain schema of the knowledge graph. Then, the information retrieval program may construct the knowledge graph by integrating the domain schema and the instance data extracted from the domain documents. Then, the information retrieval program may receive a natural language (NL) query from a user and classify the NL query to determine if the NL query is answerable by the knowledge graph. In response to determining that the NL query is answerable by the knowledge graph, the information retrieval program may translate the NL query from the user into a graph language query. Thereafter, the information retrieval program may execute the graph language query on the knowledge graph to output a query response to the user.

As described previously, unstructured datasets typically comprise the majority of all enterprise-generated data. These unstructured datasets often contain valuable domain-specific information and actionable insights. Organizations have tried to operationalize their unstructured data by implementing large language models (LLM) to retrieve information from these datasets. However, given the existing limitations of LLMs (e.g., size of context window; hallucinations), there is a need for an improved information retrieval solution that is optimized for computing cost, response time, response accuracy, and scalability.

Therefore, it may be advantageous to, among other things, provide a way to generate a domain-specific knowledge graph to enable visual representation of the key entities and their relationships in a specific domain and to enable contextual understanding of the interconnectedness of the key entities and their relationships by an LLM.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

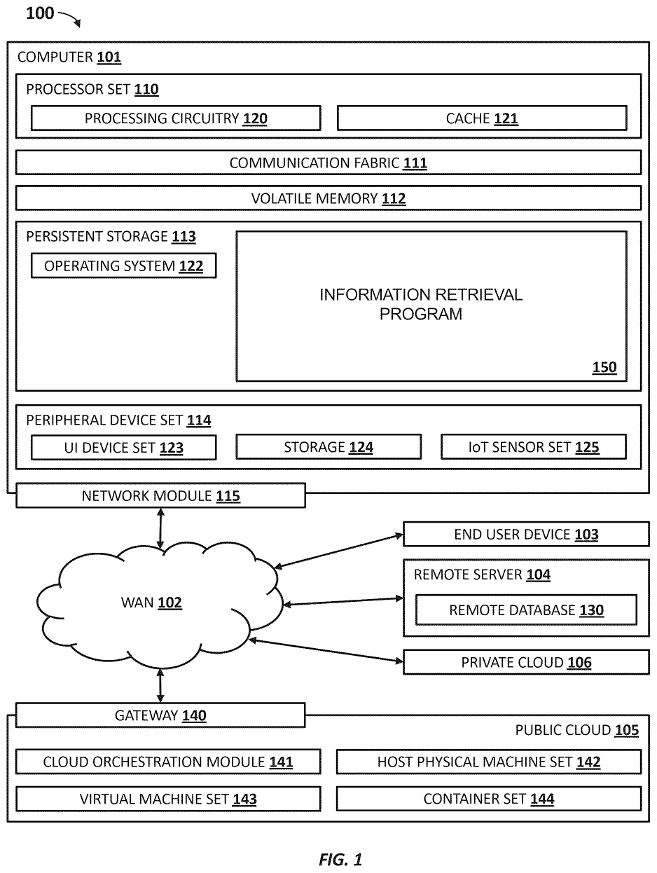

Referring to FIG. 1, a computing environment 100 according to at least one embodiment is depicted. Computing environment 100 contains an example of an environment for the execution of at least some of the computer code involved in performing the inventive methods, such as information retrieval program 150. In addition to information retrieval program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and information retrieval program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Furthermore, despite only being depicted in computer 101, information retrieval program 150 may be stored in and/or executed by, individually or in any combination, EUD 103, remote server 104, public cloud 105, and private cloud 106.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The information retrieval program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of Bluetooth SIG, Inc. and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

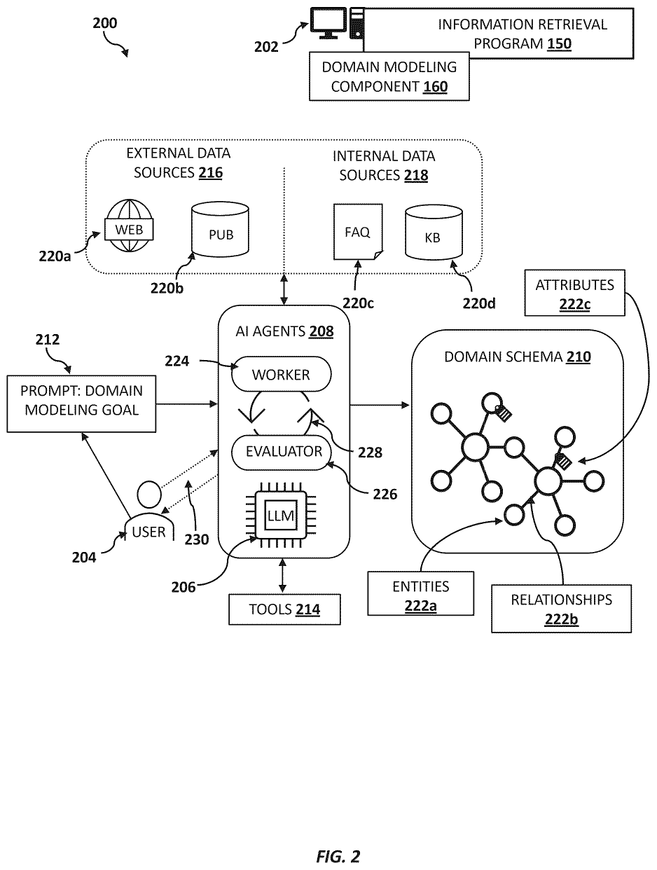

According to the present embodiment, a user using any combination of an EUD 103, remote server 104, public cloud 105, and private cloud 106 may use the IR program 150 to generate a domain-specific knowledge graph based on a domain schema determined by AI agents and instances of ingested domain data corresponding to the domain schema. Then, the user may use the information retrieval program 150 to translate a natural language (NL) query of the user into a graph query language for executing on the knowledge graph. Embodiments of the present disclosure are explained in more detail below with respect to FIGS. 2 to 5.

According to one embodiment, the information retrieval program 150 may include a single computer program or multiple program modules or sets of computer-executable instructions. In one embodiment, the information retrieval program 150 may include routines, objects, components, units, logic, data structures, and actions that may perform particular tasks or implement particular abstract data types. In one embodiment, the information retrieval program 150 may be practiced in distributed cloud computing environments where tasks may be performed by local and/or remote processing devices which may be linked through a communication network (e.g., WAN 102).

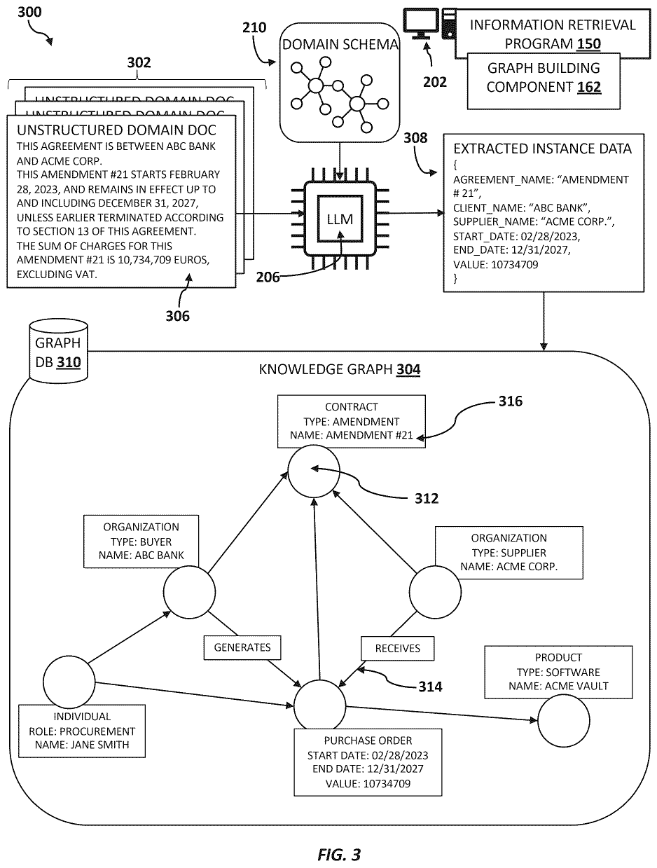

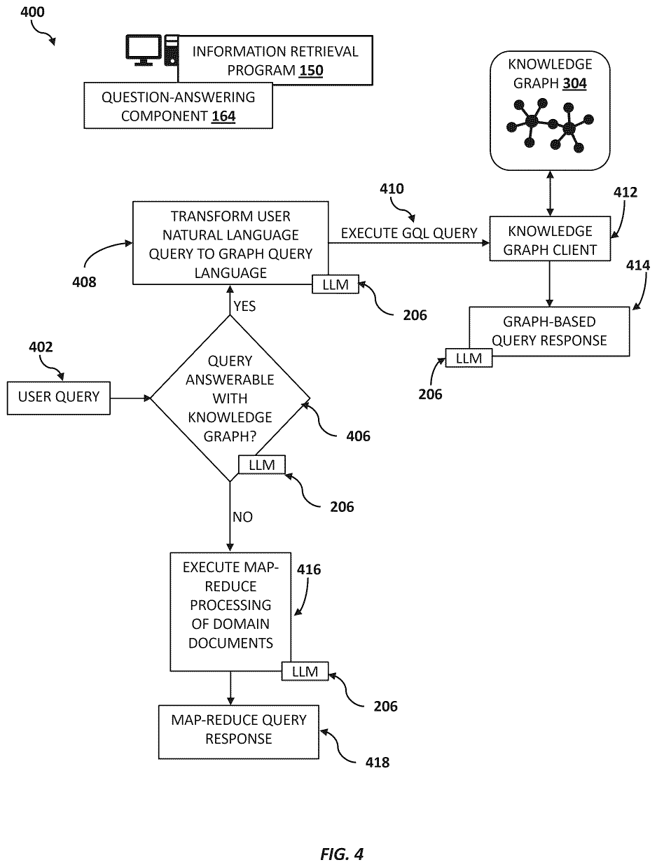

According to one embodiment, the information retrieval program 150 may include a domain modeling component 160 described with reference to FIG. 2, a graph building component 162 described with reference to FIG. 3, and a question-answering component 164 described with reference to FIG. 4.

Referring now to FIG. 2, a schematic block diagram of a domain modeling environment 200 according to at least one embodiment is depicted. According to one embodiment, the domain modeling environment 200 may include a computer system 202 having a tangible storage device and a processor that is enabled to run the information retrieval program 150. In one embodiment, the domain modeling environment 200 may be implemented by the domain modeling component 160 of the information retrieval program 150.

According to one embodiment, the computer system 202 may include one or more components (e.g., computer 101; end user device (EUD) 103; WAN 102) of the computer environment 100 described above with reference to FIG. 1. In one embodiment, the computer system 202 may include one or more computers (e.g., computer 101) which may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, and/or querying a database. In at least one embodiment, aspects of the computer system 202 may operate in a cloud computing service model, such as Software as a Service (Saas), Platform as a Service (PaaS), or Infrastructure as a Service (IaaS). In one embodiment, the computer system 202 may also be implemented as a cloud computing deployment model, such as a private cloud, community cloud, public cloud, or hybrid cloud.

According to one embodiment, the domain modeling component 160 of the information retrieval program 150 may enable a user 204 to interact with an LLM 206 to automate the domain modeling for a domain-specific knowledge graph. In one embodiment, LLM 206 may implement a plurality of AI agents 208 (e.g., multi-agent system) to autonomously generate a domain schema 210 for a domain-specific knowledge graph. In one embodiment, user 204 may input a prompt 212 indicating a domain modeling goal. Based on prompt 212 and a user-specified domain for modeling, the AI agents 208 may iteratively perform tasks to output the domain schema 210 as a response to the goal in prompt 212. In one embodiment, the AI agents 208 may call on various tools 214 (e.g., for web searches, data access, APIs, document processing) to complete their tasks.

According to one embodiment, the AI agents 208 may have access to one or more external data sources 216 (e.g., web 220a; other public databases 220b) and one or more internal data sources 218 (e.g., frequently asked questions (FAQs) 220c; other internal knowledge bases 220d) specified by the user 204. According to one embodiment, the domain schema 210 for the knowledge graph may include a structured framework of entities 222a (represented by nodes) within the specified domain, relationships 222b between pairs of entities 222a (represented by edges), and attributes 222c (represented by labels; properties that describe the entities and/or relationships between entities).

In one embodiment, a worker agent 224 (e.g., first AI agent; worker AI agent) of the plurality of AI agents 208 may use reasoning and search tools (e.g., tools 214) to search the web 220a or other public databases 220b to identify a set of key entities in the user-specified domain. In one embodiment, the LLM 206 may include pre-trained knowledge to enable the worker agent 224 to know which key entities to look for in the user-specified domain. In one embodiment, the LLM 206 may be trained using few-shot examples of key entities prepared by subject matter experts (SMEs) in the user-specified domain. In one embodiment, prompt 212 may include, based on an SME's knowledge, a specific number of entities (e.g., minimum; maximum) in the set of key entities for the worker agent 224 to identify. The entities may include, for example, objects, places, people, events, situations, or concepts. Then, the worker agent 224 may iterate over each pair of entities to identify meaningful relations between the pair of entities. In one embodiment, an evaluator agent 226 (e.g., second AI agent; evaluator AI agent) of the plurality of AI agents 208 may compare the set of key entities and relationships identified by the worker agent 224 against a list of most common questions in the user-specified domain to determine if the questions could be answered using a knowledge graph including the set of key entities and relationships identified by the worker agent 224.

In one embodiment, the LLM 206 may include pre-trained knowledge to enable the evaluator agent 226 to know which questions to look for in the user-specified domain. In one embodiment, the LLM 206 may be trained using few-shot examples of questions prepared by subject matter experts (SMEs) in the user-specified domain. In one embodiment, prompt 212 may include, based on an SME's knowledge, a specific number of questions (e.g., minimum; maximum) in the list of most common questions for the evaluator agent 226 to identify.

The list of most common questions may be retrieved from one or more of the external data sources 216 (e.g., web 220a; public database 220b) by any one of the plurality of AI agents 208. In one embodiment, there may be a feedback mechanism 228 between the plurality of AI agents 208. As such, if the evaluator agent 226 determines that all of the most commons questions in the domain cannot be answered by the set of key entities and relationships identified by the worker agent 224, the evaluator agent 226 may provide feedback to the worker agent 224 to identify any missing entities and relationships that may need to be added to the domain schema 210 to answer the questions. In at least one embodiment, the information retrieval program 150 may enable a human-in-the-loop (HITL) mechanism 230 such that the user 204 (or another domain expert) may provide feedback to the plurality of AI agents 208 to improve the accuracy of their responses. In one embodiment, the set of key entities and relationships identified by the worker agent 224 may be compared with a set of domain-specific frequently asked questions (FAQs) 220c retrieved from internal data sources 218 (e.g., organization database or other internal knowledge base 220d). It is contemplated that the FAQs 220c may include the most frequent real-time questions asked in the organization regarding the specified domain. As such, the AI agents 208 may work to ensure that the set of key entities and relationships identified by the worker agent 224 would be able to answer real-time internal FAQs 220c.

According to one embodiment, the information retrieval program 150 may enable the AI agents 208 to directly generate the domain schema 210 from the internal data sources 218, such as, FAQs 220c. In the context of data from FAQs 220c, the goal of the AI agents 208 may be to extract key concepts, relationships, and information from the questions and answers and represent it in a structured form. To convert the FAQs 220c into structured information, the worker agent 224 may apply natural language processing (NLP) techniques to identify entities such objects, places, people, events, time frames, situations, or concepts (e.g., “employees,” “tenure,” “25 years”). In one embodiment, the worker agent 224 may apply NLP to understand intent to determine what the user seeks in each question (e.g., asking for information, making a request). In one embodiment, the worker agent 224 may apply NLP to categorize questions based on topics, like shipping, returns, or account management. In one embodiment, once entities are identified, the worker agent 224 may categorize the entities into meaningful groups and analyze the relationships between these entities. In one embodiment, the worker agent 224 may extract relationships to define how entities are connected (e.g., “a procurement document might have a hierarchy of documents”). Then, the worker agent 224 may organize the extracted data into the domain schema 210 including entities 222a, relationships 222b, and attributes 222c. In one embodiment, the domain schema 210 may also indicate one or more constraints or rules on the types of entities, attributes, and relationships allowed within the knowledge graph.

Referring now to FIG. 3, a schematic block diagram of a graph building environment 300 according to at least one embodiment is depicted. According to one embodiment, the graph building environment 300 may include the computer system 202 (e.g., described in FIG. 2) having a tangible storage device and a processor that is enabled to run the information retrieval program 150. In one embodiment, the graph building environment 300 may be implemented by the graph building component 162 of the information retrieval program 150.

According to one embodiment, the graph building component 162 of the information retrieval program 150 may enable the user 204 (FIG. 2) to transform a plurality of unstructured domain documents 302 (e.g., Purchase Request, Request for Quotation (RFQ), Request for Proposal (RFP), Purchase Order (PO), Contract, Invoice, Delivery Receipt, and Supplier Evaluation Form documents related to procurement domain) into a structured domain-specific knowledge graph 304. In one embodiment, the LLM 206 (or AI agents 208 executed by the LLM 206) may process the domain schema 210 and each document 306 of the plurality of unstructured domain documents 302 to extract instance data 308 corresponding to the domain schema 210. For example, if the domain schema 210 indicates a contract entity and a supplier entity, the LLM 206 may extract, from document 306, the name of the contract (e.g., “amendment #21” in FIG. 3) and the name of the supplier (e.g., “Acme Corp” in FIG. 3) to be included in the extracted instance data 308. Then, the graph building component 162 may implement the LLM 206 206 (or AI agents 208 executed by the LLM 206) to construct the knowledge graph 304 by integrating the domain schema 210 and the plurality of extracted instance data 308 extracted from the plurality of domain documents 302.

According to one embodiment, the information retrieval program 150 may store the knowledge graph 304 in a graph database 310. Each node 312 of the knowledge graph 304 may represent an entity and store the extracted instance data 308 corresponding to that entity. Similarly, each edge 314 of the knowledge graph 304 may represent a relationship between a pair of entities and store the extracted instance data 308 corresponding to that relationship. Further, each label 316 of the knowledge graph 304 may represent properties that describe the entities and/or relationships between entities.

Referring now to FIG. 4, a schematic block diagram of a question-answering environment 400 according to at least one embodiment is depicted. According to one embodiment, the question-answering environment 400 may include the computer system 202 (described with reference to FIG. 2) having a tangible storage device and a processor that is enabled to run the information retrieval program 150. In one embodiment, the question-answering environment 400 may be implemented by the question-answering component 164 of the information retrieval program 150.

According to one embodiment, the question-answering component 164 of the information retrieval program 150 may receive a natural language (NL) query 402 from a user (e.g., user 204) and determine (e.g., decision 406) if the NL query 402 is answerable by the knowledge graph 304 described in FIG. 3. In one embodiment, the information retrieval program 150 may implement decision 406 by using LLM 206 (or AI agents 208 executed by the LLM 206) to classify the NL query 402 as either answerable by the knowledge graph 304 (“Yes” branch) or not answerable by the knowledge graph 304 (“No” branch). The LLM 206 may classify the NL query 402 as answerable by the knowledge graph 304 if the entities, relationships, and/or attributes described in the NL query 402 are also described (e.g., stored) in the knowledge graph 304 (e.g., in corresponding nodes 312, edges 314, labels 316). If the NL query 402 is answerable by the knowledge graph 304, LLM 206 transforms 408 (e.g., translates) the NL query 402 into a graph language query (e.g., Cypher, Gremlin, SPARQL). Thereafter, the question-answering component 164 may execute 410 the graph language query on the knowledge graph 304 using a knowledge graph client 412. Then, the information retrieval program 150 may implement the LLM 206 to output a graph-based query response 414 to the user based on any query-answer data found in the knowledge graph 304.

However, if LLM 206 classifies the NL query 402 as not answerable by the knowledge graph 304 (“No” branch), the information retrieval program 150 may implement the LLM 206 to execute map-reduce processing 416 of the plurality of domain documents 302 (e.g., stored in knowledge base 220d). In map-reduce processing 416, the information retrieval program 150 may apply the LLM 206 to each document 306 individually (the Map step), treating the LLM 206 output as a new document. Then, the information retrieval program 150 may combine all the new documents in a separate combined document. Thereafter, the information retrieval program 150 may pass the separate combined document to the LLM 206 to get a single output (the Reduce step) which may be used to generate map-reduce query response 418 to the NL query 402.

According to one embodiment, LLM 206 may classify the NL query 402 as not answerable by the knowledge graph 304 (“No” branch) if the entities, relationships, and/or attributes described in the NL query 402 are not described (e.g., stored) in the knowledge graph 304 (e.g., in corresponding nodes 312, edges 314, labels 316). In one embodiment, the domain schema 210 of the knowledge graph 304 (and in turn the knowledge graph 304) may be dynamically updated if the NL queries 402 are classified by the LLM 206 as not answerable by the knowledge graph 304. In one embodiment, if the NL query 402 that is not answerable by the knowledge graph 304 is added to FAQs 220c, the information retrieval program 150 may implement the LLM 206 to update the domain schema 210 (and in turn the knowledge graph 304) to include any missing entities, relationships, and/or attributes that may be important to answer the most frequently asked questions in real-time.

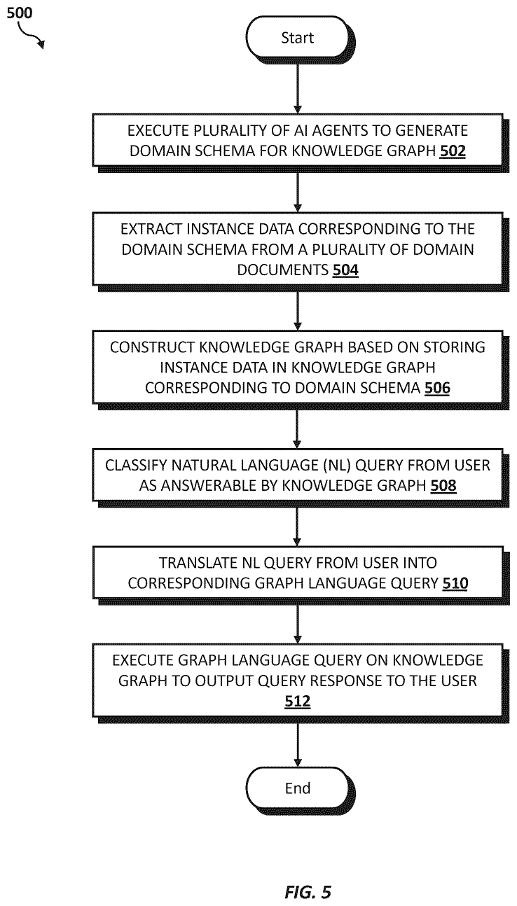

Referring now to FIG. 5, an operational flowchart illustrating an exemplary process 500 used by the information retrieval program 150 according to at least one embodiment is depicted. FIG. 5 provides a description of process 500 which was also described with reference to the domain modeling environment 200 (FIG. 2), the graph building environment 300 (FIG. 3), and the question-answering environment 400 (FIG. 4).

At 502, a plurality of AI agents are executed to generate a domain schema for a knowledge graph. According to one embodiment, the information retrieval program 150 may execute a first AI agent (e.g., worker agent) of the plurality of AI agents to identify, in at least one external data source (e.g., web), a set of key entities and relationships for including in the domain schema associated with a specific domain. In one embodiment, the information retrieval program 150 may also execute a second AI agent (e.g., evaluator agent) of the plurality of AI agents to identify, in the at least one external data source (e.g., web), a set of key questions associated with the specific domain. In one embodiment, the second AI agent may determine whether the set of key questions associated with the specific domain are answerable using the set of key entities and relationships identified by the first AI agent.

According to one embodiment, the information retrieval program 150 may implement the plurality of AI agents to retrieve a set of frequently asked questions from at least one internal data source. In one embodiment, the plurality of AI agents may extract, by natural language processing, a plurality of entities, relationships, and attributes from the set of frequently asked questions retrieved from the at least one internal data source. Then, the plurality of AI agents may generate the domain schema using the plurality of entities, relationships, and attributes extracted from the set of frequently asked questions. An example of 502 is described with reference to FIG. 2.

Then at 504, a plurality of instance data corresponding to the domain schema are extracted from a plurality of domain documents. According to one embodiment, the information retrieval program 150 may transform a plurality of unstructured domain documents into a structured domain-specific knowledge graph. In one embodiment, the information retrieval program 150 may implement the LLM (or AI agents executed by the LLM) to process the domain schema and each document of the plurality of unstructured domain documents to extract instance data corresponding to the domain schema. An example of 504 is described with reference to FIG. 3.

Then at 506, the knowledge graph is constructed by integrating the domain schema and the plurality of instance data extracted from the plurality of domain documents. According to one embodiment, the information retrieval program 150 may store the knowledge graph in a graph database. Each node of the knowledge graph may represent an entity and store the extracted instance data corresponding to that entity. Similarly, each edge of the knowledge graph may represent a relationship between a pair of entities and store the extracted instance data indicating that relationship. Further, each label of the knowledge graph may represent properties that describe the entities and/or relationships between entities. An example of 506 is described with reference to FIG. 3.

Then at 508, a natural language (NL) query from a user is classified as answerable by the knowledge graph. According to one embodiment, the information retrieval program 150 may receive an NL query from a user and determine if the NL query is answerable by the knowledge graph. In one embodiment, the information retrieval program 150 may implement an LLM (or AI agents executed by the LLM) to classify the NL query as either answerable by the knowledge graph or not answerable by the knowledge graph. The LLM may classify the NL query as answerable by the knowledge graph if the entities, relationships, and/or attributes described in the NL query are also described (e.g., stored) in the knowledge graph (e.g., in corresponding nodes, edges, labels). An example of 508 is described with reference to FIG. 4.

Then at 510, the NL query from the user is translated into a graph language query. If the NL query is determined to be answerable by the knowledge graph, the information retrieval program 150 may implement the LLM to transform the NL query into a graph language query (e.g., Cypher, Gremlin, SPARQL) via translation techniques. An example of 510 is described with reference to FIG. 4.

Thereafter at 512, the graph language query is executed on the knowledge graph to output a graph-based query response to the user. According to one embodiment, the information retrieval program 150 may execute the graph language query on the knowledge graph using a knowledge graph client. Then, the information retrieval program 150 may implement the LLM to output a graph-based query response to the user based on any query-answer data found in the knowledge graph. An example of 512 is described with reference to FIG. 4.

It is contemplated that the information retrieval program 150 may provide several advantages and/or improvements to the technical field of information retrieval systems. The information retrieval program 150 may also improve the functionality of a computer because the information retrieval program 150 may enable the computer to solve for LLM limitations when answering questions from multiple documents with logical operators (e.g., and, or, not) and comparison operators (e.g., >, <, =). The information retrieval program 150 may also improve the functionality of a computer because the information retrieval program 150 may enable the computer to solve for the limitations of question-answering systems where answers cannot be found in a single document but instead by analysing the relationship between different concepts from multiple documents. The information retrieval program 150 may provide the above functionality and optimize for computing cost, response time, response accuracy, and scalability of information retrieval systems.

It may be appreciated that FIGS. 2 to 5 provide only an illustration of one embodiment and do not imply any limitations with regard to how different embodiments may be implemented. Many modifications to the depicted embodiment(s) may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
executing, by an information retrieval system, a plurality of AI agents to generate a domain schema for a knowledge graph, wherein executing the plurality of AI agents comprises:
identifying, by a first AI agent of the plurality of AI agents, entities and relationships for inclusion in the domain schema;
determining, by a second AI agent of the plurality of AI agents, that at least one question associated with a domain is not answerable using the entities and relationships; and
in response to determining that the at least one question is not answerable using the entities and relationships, providing, by the second AI agent to the first AI agent, feedback to identify one or more missing entities or relationships for inclusion in the domain schema;
extracting, by the information retrieval system from a plurality of unstructured domain documents, instance data corresponding to the domain schema;
constructing, by the information retrieval system, the knowledge graph by integrating the domain schema and the instance data, wherein the knowledge graph is stored in a graph database;
classifying, by the information retrieval system, a natural language (NL) query received from a user as answerable by the knowledge graph based on determining that one or more entities, relationships, or attributes described in the NL query are stored in the knowledge graph;
translating, by the information retrieval system, the NL query from the user into a graph language query; and
executing, by the information retrieval system, the graph language query on the knowledge graph stored in the graph database to output a graph-based query response to the user.

2. The computer-implemented method of claim 1, wherein
the entities and relationships comprise a set of key entities and relationships identified, by the first AI agent, in at least one external data source for inclusion in the domain schema associated with the domain,
wherein the at least one question is included in a set of key questions identified, by the second AI agent, in the at least one external data source, and
wherein determining that the at least one question associated with the domain is not answerable using the entities and relationships comprises determining that the at least one question of the set of key questions is not answerable using the set of key entities and relationships.

3. The computer-implemented method of claim 1, wherein executing the plurality of AI agents to generate the domain schema for the knowledge graph further comprises:
retrieving a set of frequently asked questions from at least one internal data source;
extracting, by natural language processing, a plurality of entities, relationships, and attributes from the set of frequently asked questions retrieved from the at least one internal data source; and
generating the domain schema using the plurality of entities, relationships, and attributes extracted from the set of frequently asked questions.

4. The computer-implemented method of claim 1, wherein classifying the NL query received from the user as answerable by the knowledge graph further comprises:
determining that a plurality of query entities, relationships, and attributes described in the NL query are stored in the knowledge graph.

5. The computer-implemented method of claim 1, further comprising:
classifying, by the information retrieval system, a second NL query received from the user as not answerable by the knowledge graph responsive to determining that one or more second entities, relationships, or attributes described in the second NL query are not stored in the knowledge graph.

6. The computer-implemented method of claim 5, further comprising:
in response to classifying the second NL query as not answerable by the knowledge graph, executing, by the information retrieval system, a map-reduce process of the plurality of unstructured domain documents to generate a map-reduce query response to the second NL query.

7. The computer-implemented method of claim 5, further comprising:
in response to classifying the second NL query as not answerable by the knowledge graph, updating the domain schema to include the one or more second entities, relationships, or attributes described in the second NL query.

8. A computer system for question-answering, comprising:
one or more processors, one or more computer-readable memories, one or more computer-readable tangible storage media, and program instructions stored on at least one of the one or more computer-readable tangible storage media for execution by at least one of the one or more processors via at least one of the one or more memories, wherein the computer system is capable of performing a method comprising:
executing, by an information retrieval system, a plurality of AI agents to generate a domain schema for a knowledge graph, wherein executing the plurality of AI agents comprises:
identifying, by a first AI agent of the plurality of AI agents, entities and relationships for inclusion in the domain schema;
determining, by a second AI agent of the plurality of AI agents, that at least one question associated with a domain is not answerable using the entities and relationships; and
in response to determining that the at least one question is not answerable using the entities and relationships, providing, by the second AI agent to the first AI agent, feedback to identify one or more missing entities or relationships for inclusion in the domain schema;
extracting, by the information retrieval system from a plurality of unstructured domain documents, instance data corresponding to the domain schema;
constructing, by the information retrieval system, the knowledge graph by integrating the domain schema and the instance data, wherein the knowledge graph is stored in a graph database;
classifying, by the information retrieval system, a natural language (NL) query received from a user as answerable by the knowledge graph based on determining that one or more entities, relationships, or attributes described in the NL query are stored in the knowledge graph;
translating, by the information retrieval system, the NL query from the user into a graph language query; and
executing, by the information retrieval system, the graph language query on the knowledge graph stored in the graph database to output a graph-based query response to the user.

9. The computer system of claim 8, wherein
the entities and relationships comprise a set of key entities and relationships identified, by the first AI agent, in at least one external data source for inclusion in the domain schema associated with the domain,
wherein the at least one question is included in a set of key questions identified, by the second AI agent, in the at least one external data source, and
wherein determining that the at least one question associated with the domain is not answerable using the entities and relationships comprises determining that the at least one question of the set of key questions is not answerable using the set of key entities and relationships.

10. The computer system of claim 8, wherein executing the plurality of AI agents to generate the domain schema for the knowledge graph further comprises:
retrieving a set of frequently asked questions from at least one internal data source;
extracting, by natural language processing, a plurality of entities, relationships, and attributes from the set of frequently asked questions retrieved from the at least one internal data source; and
generating the domain schema using the plurality of entities, relationships, and attributes extracted from the set of frequently asked questions.

11. The computer system of claim 8, wherein classifying the NL query received from the user as answerable by the knowledge graph further comprises:
determining that a plurality of query entities, relationships, and attributes described in the NL query are stored in the knowledge graph.

12. The computer system of claim 8, further comprising:
classifying, by the information retrieval system, a second NL query received from the user as not answerable by the knowledge graph responsive to determining that one or more second entities, relationships, or attributes described in the second NL query are not stored in the knowledge graph.

13. The computer system of claim 12, further comprising:
in response to classifying the second NL query as not answerable by the knowledge graph, executing, by the information retrieval system, a map-reduce process of the plurality of unstructured domain documents to generate a map-reduce query response to the second NL query.

14. The computer system of claim 12, further comprising:
in response to classifying the second NL query as not answerable by the knowledge graph, updating the domain schema to include the one or more second entities, relationships, or attributes described in the second NL query.

15. A computer program product for question-answering, comprising:
one or more computer-readable storage media and program instructions collectively stored on the one or more computer-readable storage media, the program instructions executable by a processor to cause the processor to perform a method comprising:
executing, by an information retrieval system, a plurality of AI agents to generate a domain schema for a knowledge graph, wherein executing the plurality of AI agents comprises:
identifying, by a first AI agent of the plurality of AI agents, entities and relationships for inclusion in the domain schema;
determining, by a second AI agent of the plurality of AI agents, that at least one question associated with a domain is not answerable using the entities and relationships; and
in response to determining that the at least one question is not answerable using the entities and relationships, providing, by the second AI agent to the first AI agent, feedback to identify one or more missing entities or relationships for inclusion in the domain schema;
extracting, by the information retrieval system from a plurality of unstructured domain documents, instance data corresponding to the domain schema;
constructing, by the information retrieval system, the knowledge graph by integrating the domain schema and the instance data, wherein the knowledge graph is stored in a graph database;
classifying, by the information retrieval system, a natural language (NL) query received from a user as answerable by the knowledge graph based on determining that one or more entities, relationships, or attributes described in the NL query are stored in the knowledge graph;
translating, by the information retrieval system, the NL query from the user into a graph language query; and
executing, by the information retrieval system, the graph language query on the knowledge graph stored in the graph database to output a graph-based query response to the user.

16. The computer program product of claim 15, wherein
the entities and relationships comprise a set of key entities and relationships identified, by the first AI agent, in at least one external data source for inclusion in the domain schema associated with the domain,
wherein the at least one question is included in a set of key questions identified, by the second AI agent, in the at least one external data source, and
wherein determining that the at least one question associated with the domain is not answerable using the entities and relationships comprises determining that the at least one key question of the set of key questions is not answerable using the set of key entities and relationships.

17. The computer program product of claim 15, wherein executing the plurality of AI agents to generate the domain schema for the knowledge graph further comprises:
retrieving a set of frequently asked questions from at least one internal data source;
extracting, by natural language processing, a plurality of entities, relationships, and attributes from the set of frequently asked questions retrieved from the at least one internal data source; and
generating the domain schema using the plurality of entities, relationships, and attributes extracted from the set of frequently asked questions.

18. The computer program product of claim 15, wherein classifying the NL query received from the user as answerable by the knowledge graph further comprises:
determining that a plurality of query entities, relationships, and attributes described in the NL query are stored in the knowledge graph.

19. The computer program product of claim 15, further comprising:
classifying, by the information retrieval system a second NL query received from the user as not answerable by the knowledge graph responsive to determining that one or more second entities, relationships, or attributes described in the second NL query are not stored in the knowledge graph.

20. The computer program product of claim 15, further comprising:
in response to classifying the second NL query as not answerable by the knowledge graph, executing, by the information retrieval system, a map-reduce process of the plurality of unstructured domain documents to generate a map-reduce query response to the second NL query.
